(19) United States
(12) Patent Application Publication
(10) Pub. No.: US 2010/0262456 A1
(43) Pub. Date: Oct. 14, 2010

(54) System and Method for Deep Targeting Advertisement Based on Social Behaviors

(76) Inventors: Jun Feng, Mountain View, CA (US); Jianbin Wei, Redwood City, CA (US)

Correspondence Address: STATTLER - SUH PC, 60 SOUTH MARKET STREET, SUITE 480, SAN JOSE, CA, 95113, US

(21) Appl. No.: 12/420,638

(22) Filed: Apr. 8, 2009

(51) Int. Cl. G06Q 30/00; G06N 5/02; G06Q 10/00; G06Q 99/00

(52) U.S. Cl. 705/10; 706/47; 705/14.53; 705/14.66

(57) ABSTRACT

A method and system to display a targeted online advertisement to a targeted online user based on offline behavior profiles. The method include techniques for identifying offline behavior aspects of the online user through a variety of databases, including databases of physical sites visited, databases of transactions and amounts, databases pertaining to retail loyalty cards and databases hosting occurrence of real world events. Techniques employed for codifying offline behavior include classifying behavior into categories or groups, categorizing behavior by location of an event, size of expenditure, nature of event, frequency of event, and/or periodicity of event. Having established some codified offline behavior of the online user, the system proceeds by correlating some aspect of user's offline behavior to some aspect of an online advertisement. Given the correlation between the user's offline behavior and the targeting characteristics of the advertisement, the advertisement is optionally customized and displayed to the targeted user.

### FIELD OF THE INVENTION

The information disclosed in this patent relates to displaying an Internet advertisement as a function of offline user behavior.

### BACKGROUND OF THE INVENTION

The marketing of products and services online over the Internet through advertisements is big business. Internet advertising presently is experiencing unabated growth. Unlike print and television advertisement that primarily seeks to reach a target audience, Internet advertising seeks to reach target individuals. The individuals need not be in a particular geographic location. Moreover, Internet advertisers may elicit responses and receive instant responses from individuals. As a result, Internet advertising is a much more cost effective channel in which to advertise.

Many websites host advertisements of others as a way to generate revenue. Advertisers may pay these websites on a cost per impression basis (CPM), a cost per click (CPC), or cost per action accomplished (CPA), or under some other agreed upon billable event. A goal of online advertising is to improve sales for the advertisers and increase the billable events for the host website. What is needed is a system to address these and other issues.

### SUMMARY

A method and system to display a targeted online advertisement to a targeted online user based on offline behavior profiles. The method include techniques for identifying offline behavior aspects of the online user through a variety of databases, including databases of physical sites visited, databases of transactions and amounts, databases pertaining to retail loyalty cards and databases hosting occurrence of real world events. Techniques employed for codifying offline behavior include classifying behavior into categories or groups, categorizing behavior by location of an event, size of expenditure, nature of event, frequency of event, and/or periodicity of event. Having established some codified offline behavior of the online user, the system proceeds by correlating some aspect of user's offline behavior to some aspect of an online advertisement. Given the correlation between the user's offline behavior and the targeting characteristics of the advertisement, the advertisement is optionally customized and displayed to the targeted user.

### BRIEF DESCRIPTION OF THE DRAWINGS

FIG. 1 is a block diagram illustrating a system for deep targeting advertisement based on social behaviors, according to one embodiment.

FIG. 2A shows a data flow diagram of a correlation engine for retrieving and managing offline data according to one embodiment.

FIG. 2B is a drawing of a data structure object, according to one embodiment.

FIG. 3A is a flowchart illustrating a method to display an online advertisement to a user within a system for deep targeting advertisement based on social behaviors, according to one embodiment.

FIG. 3B is a flowchart illustrating a method for presenting a display online advertisement to user within a system for deep targeting advertisement based on social behaviors, according to one embodiment.

FIG. 4 is an operations chart illustrating a method for presenting an online advertisement to a user within a system for deep targeting advertisement based on social behaviors, according to one embodiment.

FIG. 5 illustrates a network environment for operation of the system 100.

FIG. 6 is a diagrammatic representation of a machine in the exemplary form of a computer system, within which a set of instructions may be executed.

FIG. 7 is a diagrammatic representation of several computer systems in the exemplary form of a server network, within which environment a communication protocol may be executed.

### DETAILED DESCRIPTION

Deep targeting of advertisements based on combined online and offline social behaviors aims to provide higher click-through-rates and more revenue. Although users' online behaviors (e.g. clicks, traversal of links, etc) can be used to predict user response to a particular advertisement, in some cases offline behavior might also be an accurate predictor of user response to an advertisement. And in some cases, user response to a particular advertisement including further offline behavior (e.g. buying something at a store) can also be predicted. Thus, an Internet display advertising system that employs techniques for deep targeting of advertisements based on combined online and offline social behaviors might result in better performance for the advertiser, and a better online experience for the user.

Various embodiments of this invention addresses deep targeting advertisement based on combined online and offline behaviors. Given a user's profile including characteristics of certain offline behaviors, an online advertising system might be able to select and present advertisements that are more relevant than would be the case if selection and presentation were based on online behaviors only. Offline social behaviors include activities that users (e.g. prospective customers) conduct using human-machine interfaces other than online interfaces. For example, activities such as grocery shopping, dining out, traveling, buying a car, etc. might result in human-machine interface events such as a debit card swipe, or passing through an Easy-Pass/RFID toll booth, or transacting for a good or service where the transaction is entered into some machine-readable format.

Such behaviors are often related to money spending, and might be correlated such that certain user behaviors can be predicted. A combination of online behavior (e.g. as may be stored in a user's cookie or in a user-completed online profile), and offline behaviors (as might be periodically captured and correlated) might offer a more complete “real world” profile of a prospective customer. Targeting advertisements to a user based on such a more complete “real world” profile might result in measurably more relevant advertisements being presented to a given user. Accordingly, applications of embodiments of this invention might significantly increase click-through-rate, advertisement revenue, and other business metrics (e.g. cost per survey taken, cost per actual transaction, etc). Extending this deep targeting concept, it can be seen that even if offline behavior of a particular targeted user is not known, the offline behavior of other correlated users might be used to select and deliver a set of relevant advertisements. For example, when the incidence of visits to a coffee shop is high for other correlated users (e.g. sharing the same zip code, or living in the same building), an advertisement can be selected and displayed to the user based on the relevance to the other deeply correlated users.

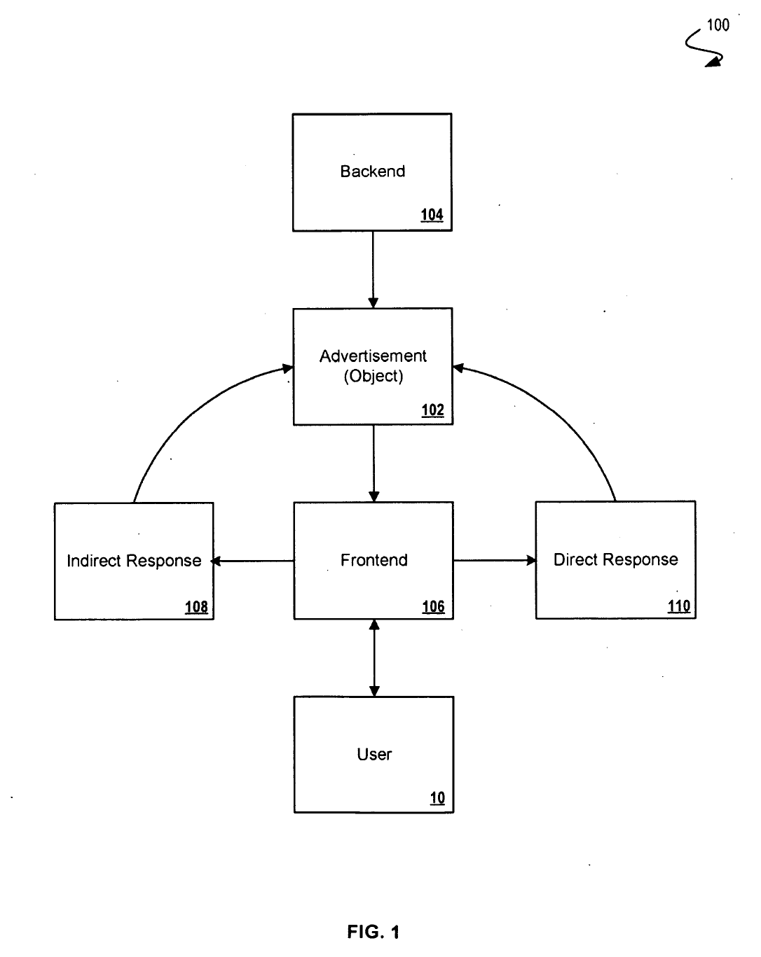

FIG. 1 is a block diagram illustrating a system 100 for deep targeting advertisement based on social behaviors, according to one embodiment. System 100 may be a group of independent but interrelated elements that may determine whether to display a given advertisement 102 to a given user 10. The decision to display advertisement 102 to the individual behind user 10 is important because each display—each advertising impression made on a computer screen—may mean that an advertiser has incurred a cost for that advertising impression. On the Internet, advertising impressions reach into the millions rather quickly and each of those millions of advertising impressions may represent millions of cost-incurring events by the advertiser. By reducing the number of advertising impressions to those more likely to result in a prospective customer 10 taking the advertiser's intended action, system 100 may improve the return on investment for the advertiser and may also improve the online experience of user 10.

System 100 may make the decision to display advertisement 102 to user 10 based on correlations between a given advertisement 102 and a given user 10. Those correlations may be based on any codifiable behaviors of user 10 (e.g. online behavior, offline behavior) or may even be based on behaviors of users other than user 10 where the behaviors of the other users correlate in some way to user 10. For example, the likelihood of a user to patronize a discount gasoline station might be correlated to other users' frequency of patronizing a discount gasoline station through a common characteristic of ownership of (for example) an older model automobile. Of course, the foregoing is strictly an example, and any correlation or even multiple correlations between any known or predictable characteristic, aspect or behavior (e.g. online, offline) of a user 10 and any known or predictable characteristic, aspect or behavior of another group of users might be included in decision criteria to present a particular advertisement to a particular user.

Continuing this discussion of correlation, and returning to the exemplary system 100 of FIG. 1, included in the system 100 is a Frontend 106, within which certain embodiments may determine correlations between advertisement 102 and user 10 by predicting whether user 10 has a makeup similar to other users who responded to advertisement 102. Here, system 100 may seek to match an online advertisement 102 to those users 10 who may have some sort of interest in or are in some way correlated to advertisement 102.

Prior online user behaviors such as click-through events, suggestions, opinions, and movement behaviors (e.g. mouse movements, scrolling, etc), as well as any one or more of a variety of offline behaviors, may be set out as metadata in advertisement 102. On determining that a present user 10 may be a match for advertisement 102, system 100 may display advertisement 102 to user 10.

System 100 may include a backend 104. Advertisement 102 may receive initial input from backend 104 and convey itself to user 10 at frontend 106. User 10 may indirectly or directly respond to advertisement 102 and feedback may be captured through an indirect response 108 and/or a direct response 110. Of course, a user response might include online behaviors that are usually immediately measurable, and/or it might include online behaviors in conjunction with previously captured offline behaviors. For example, a specific user who responded to an advertisement for product X, and later made a purchase of X on a credit card might be a good candidate to show an advertisement for product X-prime. In fact, some embodiments might analyze online and offline behaviors as correlated to a particular brand in order to extract brand-derived behavior.

Advertisement 102 may be an announcement called to the attention of the public 10. For example, advertisement 102 may include an announcement to make something known, especially to persuade people 10 to buy whatever is advertised. Advertisement 102 may be a communication to inform potential customers 10 about products and services, and about how to obtain them and use them. Advertisement 102 may be an online advertisement when displayed on an Internet web page. As display advertising-content appearing on a web page, advertisement 102 may be in a form such as a banner, a half banner, a streaming banner, a button, an interactive button ad, a clickable ad, mail, raw text, a rectangle, and/or a skyscraper and may range in size from 25×25 to 728×210, for example. Advertisement 102 may be in any other possible size or ad form.

Backend 104 may include one or more identifiers defining those responsible for the creation and management of advertisement 102. For example, an advertiser or ad agency may create advertisement 102 and may pay a host website to display and maintain advertisement 102, and the name (or code) of the advertiser and/or and the name (or code) of the ad agency might be stored with the advertisement 102. Marketers, developers, the press, publishers, and small businesses may be part of backend 104 as well, and their respective name or names (or codes) might be stored with the advertisement 102. Similarly, the frontend 106 may capture some indication (e.g. names or codes) of other individuals or groups to whom a particular advertisement 102 has been displayed.

User 10 may provide indirect response 108 about advertisement 102 such as through an online behavior feedback system and/or an offline behavior feedback system. As now becomes apparent, correlation of online behavior to offline behavior for a given user partially depends on matching the specific user 10 to that specific user's offline behaviors.

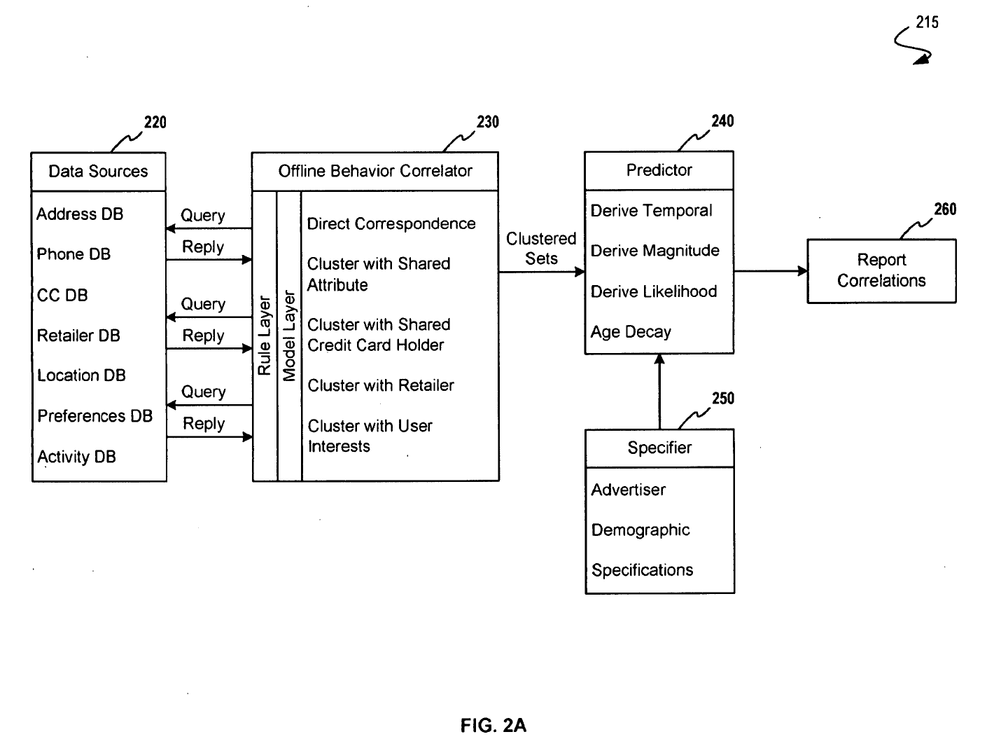

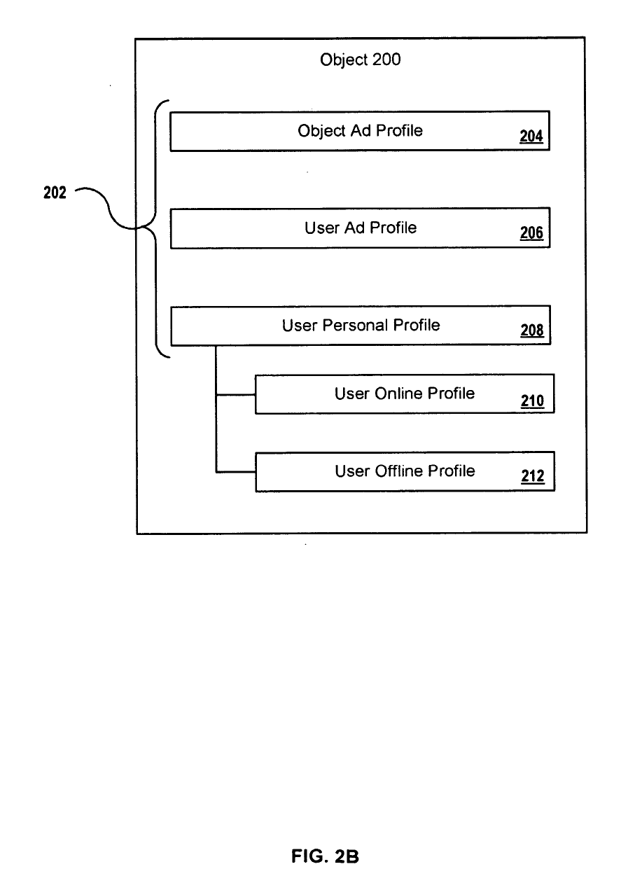

FIG. 2A shows a data flow diagram of a correlation engine for retrieving and managing offline data according to one embodiment. As an option, the present system 215 may be implemented in the context of the architecture and functionality of FIG. 1. Of course, however, the system 215 may be carried out in any desired environment. As shown, any number of data sources 220 might be queried so as to provide a query reply to an offline behavior correlator engine 230. As shown, clustering techniques are employed, however, association rule learning, collaborative filtering, principle of maximum entropy, gradient descent, and/or any other techniques for that matter might be used to resolve direct correspondence and/or draw correlations. Continuing, a predictor module 240 might identify temporal characteristics of events, possibly including recurrences of events.

Further, a predictor module 240 might calculate magnitudes, and might calculate likelihoods of specific events occurring with a specific magnitude or range. For example, the predictor 240 might derive that a particular user generally shops at “Donny's Grocery Store” (i.e. an event) with a periodicity of once a week on Wednesday or Thursday (i.e. a temporal recurrence) and spends on average $125 per event (i.e. the magnitude). Continuing the example, if this event occurs 48 times over a 52 week period the predictor module 240 might assign a likelihood of 48/52 that such an event will occur in any given week. A specifier module 250 might be used for the purpose of directing the predictor module 240 to derive specific predictions of events, or specific predictions of other information. For example, “Donny's Grocery Store” might want to know within a statistical certainty which weeks a user does not shop at Donny's and thus present an advertisement bearing some coupon or promotion intended to entice the user into a shopping event in those weeks.

It should be emphasized that the predictor 240 may analyze events over time. Accordingly the predictor module 240 includes the capability to apply a time decay to events. The time-decayed value might correspond to values used by advertisers in defining deep targeting predicates. For example, while it is of value to know that a particular user has visited Costco ten times, it might be more valuable to know that four of those visits have occurred in the most recent ninety days.

Again referring to the offline behavior correlator engine 230, users often use some common identity information that may appear in both an online profile and also in some offline “real world” database. Such information can be used as a direct correspondence to map an online customer to his/her offline identity. For instance, a customer may have used the same physical residence address in his/her online registration (e.g. Yahoo profile) as well as in his/her retailer database registration (e.g. Macy's loyalty card). Or a customer may have used the same payment method to buy from both online and physical stores. With such identity mappings, whenever a customer visits (for example) the retailer's website or a Yahoo website, the customer's identity along with his/her offline behaviors can be retrieved, at least to the extent that such offline behavior is recorded and mapped. In other cases, the true and unambiguous identity of a user might not be found directly through the aforementioned direct correspondence techniques. Accordingly, the offline behavior correlator engine 230 might query one or more data sources. Such data sources might include real address databases (e.g. for physical addresses) or virtual address databases (e.g. for network addresses), phone databases (e.g. white pages), credit card databases (e.g. VISA), retailer databases (e.g. Costco, Donny's Grocery Store), location databases (e.g. PathFinder, mobile phone carriers), activity databases (e.g. SpeedPass), and/or preferences databases (e.g. Facebook), etc.

Further on the topic of preferences databases, the aforementioned example of Facebook, is strictly an example, and the concept of a preferences database can be carried through to include preferences for people (i.e. friends). And such a preference (i.e. merely being in one's circle of Facebook friends, or being in one's LinkedIn network) might be used alone or in any combination with any other social network setting for correlating with or identifying offline behavior.

Again, returning to FIG. 1, in some embodiments, the advertisement 102 may be represented within the system as an object. The object might contain any characteristic of the advertisement to be displayed (see object ad profile 204 in FIG. 2B), any characteristic of prior user responses (see user ad profile 206 in FIG. 2B), a specific user profile (see user personal profile 208 in FIG. 2B), which may in turn contain the user online profile 210 and user offline profile 212. It should be emphasized that an advertisement 102 might be populated by any one or more of a plurality of operations within the context of a system and method for deep targeting advertisement based on social behaviors. Thus, such an object 102 may or may not be fully populated at any given point within system 100, and indeed some scenarios reach decision points such that an advertisement might not be matched to an user for display (e.g. not selected for auction, did not win at auction, etc), thus the advertisement object 102 might only be partially populated.

FIG. 2B is a drawing of an exemplary object 200. As an option, the object 200 may be implemented in the context of the architecture and functionality of FIG. 1 through FIG. 2A. Of course, however, the object 200 or any operation therein may be carried out in any desired environment. Object 200 may include any or all characteristics of advertisement 102. Object 200 may include display advertising content itself (e.g. HTML of an advertisement). Object 200 may be referred to as an ad object, an advertisement object, an online advertisement, an online advertisement object, and/or a creative. Object 200 may also include a data set 202. Conceptually, data set 202 may be a collection of data presented in tabular form that may profile object 200. Each column may represent a particular variable and each row may correspond to a given member of the data set.

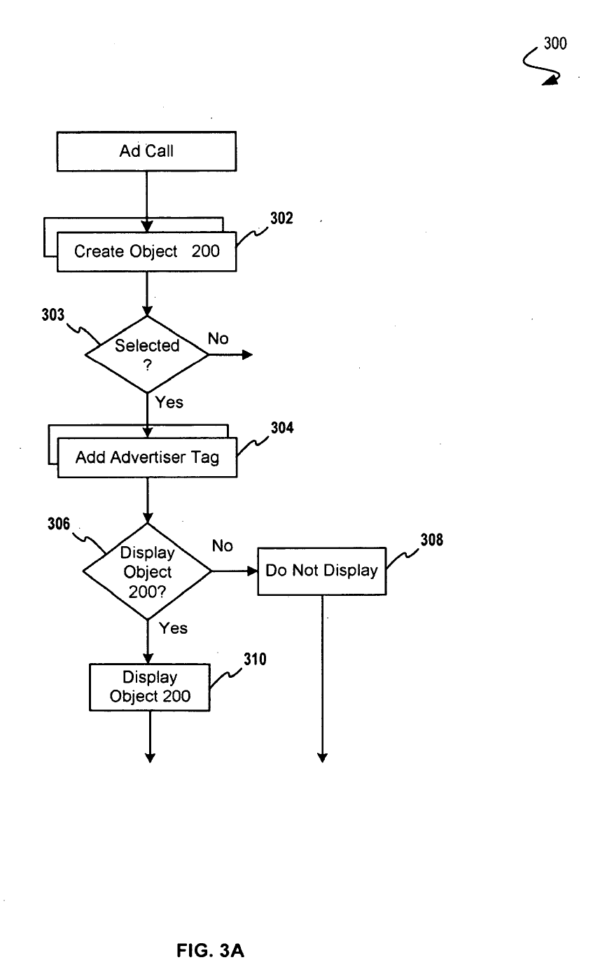

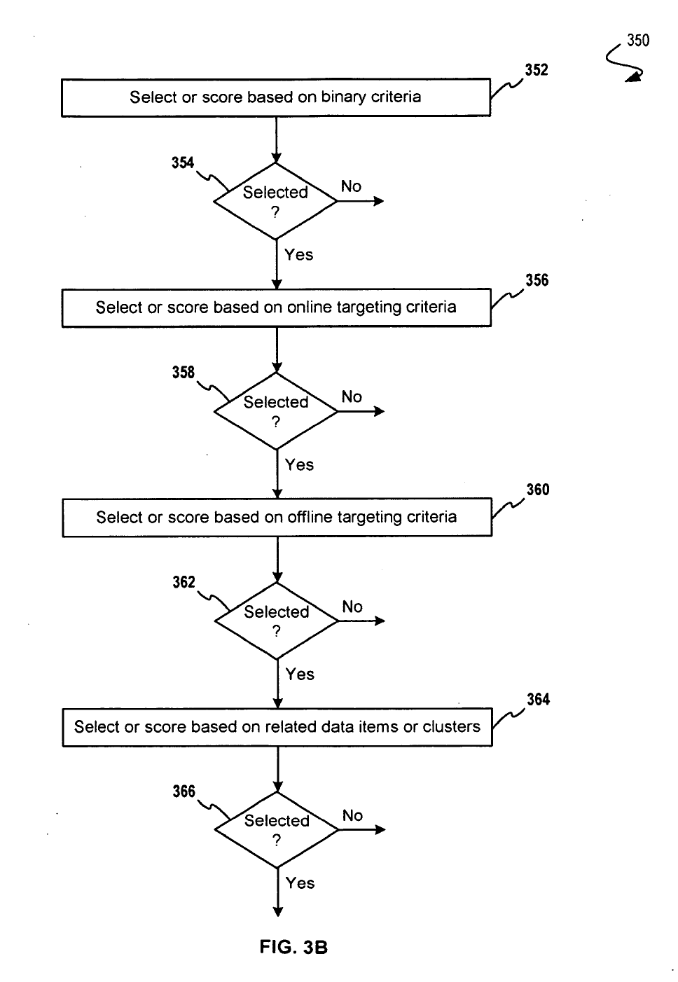

Much like how a user 10 may have a detailed personal listing in order to find a good mate through an online dating service, the object ad profile 204 may include a detailed personal style profile in order to increase the likelihood of a good match of an advertisement placement opportunity. Accordingly, the object ad profile 204 may include placement and accounting data such as position of the advertisement on a web page, interactive (rich) media/standard media, the name of the advertiser, the marketing campaign start/end, impression goal, the advertising budget, and how advertisement revenue is to be generated, such as cost per click (CPC) or cost per mille (CPM). Still further, to better match user 10 to object 200 (e.g. advertisement 102), object ad profile 204 may include additional information, such as movement behavior of any/all users to which advertisement 102 had earlier been displayed. As described in more detail in connection with FIG. 3A and FIG. 3B, such information may be augmented each time an object 200 is processed within the context of a system and method for deep targeting advertisement based on social behaviors.

In another embodiment the user ad profile 206 may be an advertisement profile of each user to whom object 200 was displayed. A user ad profile 206 may keep track of those kinds of advertising features to which each user 10 may be more likely to respond. A user ad profile 206 additionally may include data about the time of day, colors, shopping items, web page content, time by rate, and time by purchase as they relate to advertisement 102. Again, such information may be augmented each time an object 200 is processed within the context of a system and method for deep targeting advertisement based on social behaviors.

A user personal profile 208 may be a compilation of user personal profile data received from accessible personal profiles of each user 10 who may click through advertisement 102. As an example, a user personal profile 208 may keep track of the number of women who click through advertisement 102. In addition to gender, a user personal profile 208 may keep track of average ages, zip codes, email address, occupation, income level, industry, ethnographic information, purchase history, and personal interests of users 10 who may click through advertisement 102. Each of these may be analyzed to produce a user personal profile 208 as a compiled personal profile representative of the measured characteristics of all users 10 that clicked through advertisement 102.

Now, as regards offline behavior, in some embodiments the initial offline social behaviors might be retrieved through business partners that join the advertising network, such as retailers, restaurant chains, and/or financial institutions. For example, Costco has the shopping history of each of its members. Credit card companies have the time, amount, and location of their customers transactions. Of course, as time passes, the amount of offline social behaviors tends to increase in aggregation as well as scope. Behaviors can be classified into categories. For example, grocery shopping can be one category and a book purchase can be another category.

For behaviors of a customer within one category, the behavior patterns through statistical data mining techniques can be derived. Referring to an earlier example, the likelihood of an event (e.g. shopping event), the magnitude (e.g. amount), and frequency can be correlated and used in predicting the occurrence and characteristics of future events. The patterns of these behaviors can be extended to include predictions of correlated behaviors between different customers. When there are similar patterns between one user and one or more other users within one category, a correspondence of at least some similar interests are imputed to be correlated. If such similarities between one user and one or more other users can be found across multiple categories, then the interests of two customers might be considered deeply correlated.

FIG. 3A is a flowchart illustrating a method 300 to display an online advertisement to a user within a system for deep targeting advertisement based on social behaviors, according to one embodiment. As an option, the present system 300 may be implemented in the context of the architecture and functionality of FIG. 1 through FIG. 2B. Of course, however, the system 300 or any operation therein may be carried out in any desired environment. Method 300 may be implemented in a computer readable medium having a set of instructions. When executed by a computer, the set of instructions may cause the computer to display online advertisement 102 to user 10 according to method 300.

At step 302, possibly in response to an advertising call, one or more of object 200 may be created. At decision step 303, the one or more of object 200 might be rejected. Of course there are many possible criteria for rejecting (i.e. ‘selected’=‘NO’) a previously created object, and some of those criteria are covered in the discussion of FIG. 3B.

At step 304, object 200 may receive an advertiser tag as part of an object ad profile 204. Here, the creator of advertisement object 200 may provide initial data for data set 202. The data set may include data for an object ad profile 204, such as, a specification of the desired target viewer (e.g. age=28, income=>$50 k, etc) and possibly including an arbitrarily complex set of logical predicates, an advertisement placement specification for the advertisement 200 on a web page, the name of the advertiser, the marketing campaign start/end date, an impression goal, the advertising budget, and payment/cost characteristics of marketing campaign (e.g. CPC, CPM, CPA, maximum bids, etc), and other profile data.

The advertiser tag may be used, directly or indirectly, to specify the advertiser's predicates, as well as any of a wide variety of page specifications/descriptions, keywords, and any other metadata.

At step 306, method 300 may determine whether to display object 200 of advertisement 102 to user 10. If method 300 determines not to display the advertisement of object 200 to a user 10, method 300 may proceed to step 308 without displaying the object 200 to user 10. If method 300 determines to display advertisement 102 to user 10, method 300 may proceed to step 310. Of course there are many possible criteria for displaying (or not displaying) a previously created object, and some of those criteria are covered in the discussion of FIG. 3B.

The decision 306 to display or not display object 200 to user 10 may be important. Many advertising contracts may be based on page impressions, that is, the presentation of a web page containing the advertisement. Whether cost per impression or cost per 1,000 impressions (Cost per Mille, CPM), the advertising billable events may quickly add up. By making intelligent decisions on whether to display object 200 to a user 10, method 300 may reduce the number of advertising impressions by presenting only those more likely to result in a prospective customer taking the marketer's intended action (known as a marketing conversion). With the number of advertising impressions reduced, the CPM may go down while the rate of marketing conversions may increase. In other words, an advertiser's return on investment may be higher since the advertiser receives more engaged users for every impression the advertiser purchases. User 10 may benefit by seeing advertisements that may be more relevant to the needs and desires of that particular user 10.

The decision to display object 200 to user 10 may be a function of a match between (i) a personal profile of user 10 and an ad profile of user 10 (e.g. the user ad profile 206 specific to this user 10) and (ii) an object ad profile 204, a user ad profile 206 of other users 10, and a user personal profile 208.

TABLE 1

| | | B. Other |
|---|---|---|
| | A. This user 10 | contributors to object 200 |
| Correlation | 1. Personal profile of user 10 | 1. Object ad profile 204 |
| | 2. Ad profile of user 10 (206) | 2. User ad profile 206 |
| | | 3. User personal online |
| | | profile 210 |
| | | 4. User personal offline |
| | | profile 212 |

In general, data from column A may be compared to data from column B to determine characteristics or values of a match. Method 300 may then determine whether there is a correlation between data that may characterize user 10 and data that may characterize object 200. Data that may characterize user 10 may include a personal profile of user 10 and an ad profile of user 10.

Determining whether there is a correlation between user 10 and object 200 data characterization may be achieved through a variety of techniques, such as association rule learning, collaborative filtering, principle of maximum entropy, and gradient descent. In data mining and treatment learning, association rule learners may be used to discover elements that co-occur frequently within a data set. Collaborative filtering includes filtering for information or patterns using techniques involving collaboration among multiple agents, viewpoints, and data sources. The principle of maximum entropy includes analyzing available qualitative information to determine a unique epistemic probability distribution, where a least biased distribution that encodes certain given information may maximize the information entropy. In gradient descent, steps proportional to the negative of the gradient (or the approximate gradient) of the function at the current point may be taken to find a local minimum of a function.

Data for a user ad profile 206 and a user personal profile 208 may be retrieved from those users 10 for which object 200 may be displayed. For the very first display of object 200, a user ad profile 206 and a user personal profile 208 may be empty of data, and the display decision at step 306 may be based on information provided by backend 104 to an object ad profile 204. As system 100 continues to operate, the iterative processes underlying system 100 may modify and/or add to an object ad profile 204, a user ad profile 206, and/or a user personal profile 208, a user online profile 210, and/or a user offline profile 212 to improve the effectiveness of an advertisement 102 being displayed to a target user 10.

In addition to displaying object 200 to user 10, system 100 additionally may use information from a user online profile 210 to suggest to user 10 to perform certain actions, for example, to visit other property of the host website. For example, if user 10 is using Yahoo! Answers and clicks on an auto advertisement, and the match between user 10 and object 200 reveals an interest of user 10 in autos, system 100 may suggest to user 10 that they may want to visit Yahoo! Autos as well. Other property that may be suggested may include, but not be limited to, classifieds, eBay, Fifa, finance, Flickr, games, groups, health, Hotjobs, Knowledge Search, Launch.com, mail, mobile, movies, music, news, pager, personals, photos, real estate, shopping, sports, travel, and TV. Machine learning techniques to leverage existing data to extract interesting information may be used to implement this property-to-property correlation.

Considering the use of offline data, in addition to displaying object 200 to user 10, system 100 may additionally use information from a user online profile 210 to suggest to user 10 to perform certain actions, for example, to visit other websites correlated to the user offline profile. For example, if user 10 is correlated to shopping at “Donny's Grocery Store in Lower Manhattan”, then system 100 may suggest to user 10 that they may want to visit “Donny's Grocery Store in SoHo” as well. Other property visits that may be suggested include, but not be limited to, any offline or online property. Moreover, the suggestion to user 10 to perform certain actions is not limited to any particular online or offline activity. Machine learning techniques might be used to leverage existing data to extract this action-to-action correlation. In one example, the machine learning techniques may include neural networks to infer properties.

In addition to displaying object 200 to user 10, system 100 additionally may use the determination at step 306 to “re-flavor” or redesign a site based on a user 10's known offline or online behavior. For example, if user 10 tends to click on any auto ads, or is known to have made recent visits to an auto dealership, the flavor of the web pages presented to user 10 over time may become more automobile related with auto-related imagery appearing more frequently or more prominently.

At step 310, method 300 displays object 200 to user 10. In an alternate example, other useful content may first be displayed on the advertisement spot. In this example, object 200 may include code that may display other useful content on the advertisement spot instead of requesting that advertisement 200 be displayed on the advertisement spot. The useful content may include an excerpt of an informative relevant article that may lead user 10 to advertisement 200. In this example, advertisement 200 may be configured as a more powerful landing page having a more powerful message. The more powerful message may include a mix of advertisement and content. This technique may combat banner blindness where visitors on a website ignore an area of a web page merely because it contains an advertisement. Both the display of the other useful content and any subsequent display of advertisement 200 may be included in step 310 as part of displaying object 200 to user 10.

FIG. 3B is a flowchart illustrating a method 350 for presenting a display online advertisement to a user within a system for deep targeting advertisement based on social behavior, according to one embodiment. As an option, the present system 350 may be implemented in the context of the architecture and functionality of FIG. 1 through FIG. 3A. Of course, however, the system 350 or any operation therein may be carried out in any desired environment. As earlier indicated there are many possible criteria for determining not to display a previously created object. As shown in FIG. 3B, such criteria might include binary criteria (see operation 352), online targeting criteria (see operation 356), offline targeting criteria (see operation 360), or even criteria based on related data items or clusters (see operation 364). In somewhat more detail, binary criteria might be implemented by merely testing (for example) if the advertisement meets the criteria for matching a conjunctive predicate for display at that property, or (for example) if the advertisement has sufficient budget available. Similarly, various online targeting criteria might be applied by testing (for example) if the advertisement meets the criteria for matching a conjunctive predicate describing the user (e.g. advertisement directed to males, and user is a male). Or, more interestingly, offline targeting criteria might be applied by testing (for example) if the user has a sufficient history corresponding to the advertiser's targeting criteria (e.g. advertisement directed to males who have purchased an automobile within the past 30 days, and user 10 is a male who purchased an automobile within the past 12 days). Any of the aforementioned selecting/scoring operations 352, 356, 260, 364) might result in a low score or low aggregate score such that the object is not selected at any decision point 354, 358, 362, 366.

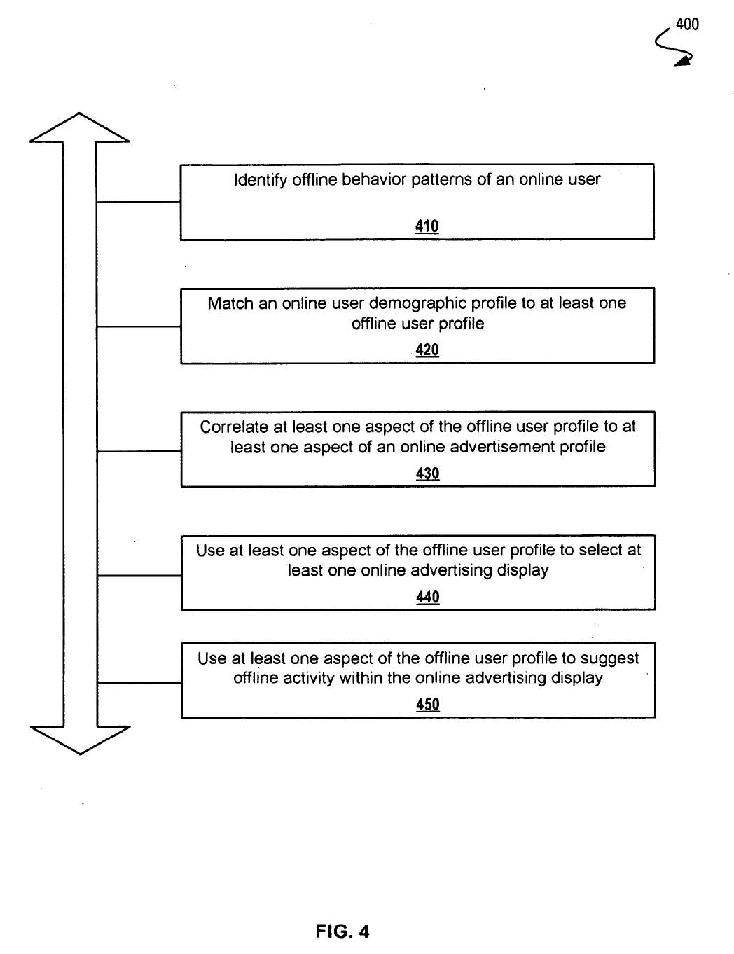

FIG. 4 is an operations chart illustrating a method for presenting an online advertisement to a user within a system for deep targeting advertisement based on social behaviors, according to one embodiment. As an option, the present system 400 may be implemented in the context of the architecture and functionality of FIG. 1 through FIG. 3B. Of course, however, the system 400 or any operation therein may be carried out in any desired environment. As shown, the system 400 initiates in operation 410 by identifying offline behavior patterns of an online user (many embodiments of which are disclosed herein). Accordingly, at least a portion of operation 420 then has the necessary data to execute, matching the user online profile to at least one other user offline profile. Operation 430 correlates one or more aspects of the user's offline profile to at least one aspect of an online advertisement profile. Thus, having at least some correlation between the online user and an online advertisement profile, operation 430 selects one or more advertisements for online display using at least one aspect of a user offline profile.

It can now be understood that once the identity of an online customer is known or, if not known, at least correlated to the extent that some offline behavior can be known or inferred, then deeply-targeted advertisements can be selected (see operation 440) for presentation to user 10. For example, assume a prospective customer is has an offline history of buying a case of some soft drink every two weeks, and such a periodicity has been extracted from the aforementioned data sources. Then, when the prospective customer is visiting a relevant website, advertisements for (possibly competing) soft drinks can be delivered to the prospective customer. Further, such delivery might be timed to occur several days before his/her next predicted shopping event. The relevance of such deep targeting of advertisements to prospective customers offers a better experience for the prospective customer (as well as an expected higher return on investment for the advertiser) as compared with delivering advertisements selected solely on information or criteria that do not include aspects of offline behavior. Thus, having delivered a better experience to the online user, operation 450 might take advantage of the captured focus of the prospective customer by suggesting some offline activity (or online activity for that matter), such as “Use this 20% off coupon”, “Visit our newest retail outlet”, “Join us in our Grand Opening”, etc. Of course, selection of such an activity might once again employ deep targeting, possibly including the use of at least one aspect of the offline user profile.

In still further disclosure of the system 400, using slightly more detailed and formal language, the system 400 implements a method for displaying an online advertisement to an online user based on offline behavioral profiles. In the embodiment shown, operation 410 serves for identifying offline behavior aspects of the online user. Such an identification step may include query/retrieval from data sources in order to identify offline events or characteristics (e.g. site visits, purchase events, transaction amounts, a stated retail preference, association with an assigned retail loyalty card, an offline event other than a transaction, the periodicity of an event). Identifying offline behavior might also include classifying behaviors or events into categories (e.g. association with a particular group, location of an event, the size or size range of expenditures, the nature of an event, frequency of an event, periodicity of an event, etc). Operation 420 serves for matching the online user's online profile to at least one online user's offline profile.

It is reasonable and envisioned that identifying offline behavior for a particular online user might be correlated (e.g. using categories or other codification techniques) to the offline behaviors of users other than the particular user himself. It must be emphasized that the matching of operation 420 might be quite simple (e.g. direct matching on the basis of a name, an address, a social security number, a user ID, etc), or it might be quite sophisticated, possibly involving the aforementioned techniques for correlation (e.g. correlation to a category, to a payment method, to an event pattern, to a group, etc), and/or may use rules (e.g. one or more retrieval rules, or one or more general rule sets, etc), and/or models (e.g. a human behavioral predictive model, a statistical predictive model, a plurality of predictive models, a Yahoo behavioral targeting predictor, etc).

As for preparing for selecting an advertisement to display to a particular user (see operation 440), the operation 430 serves for correlating at least one aspect of the online user's offline profile (which may be from the matching in operation 420) to at least one aspect of an online advertisement profile. Continuing with the earlier example, the advertisement profile may include a predicate such as “display to user's who are 85% likely to purchase a case of soft drink within the next 2 days”, and that aspect of the advertisement profile can be matched to the user's offline profile indication that it has been 5 days since the most recently recorded transaction of a case of soft drink. But, of course, selecting a specific advertisement need not be limited to matching on a single aspect. In fact, and again using the same example, it is reasonable that the advertising server hosts advertisements from both “Coke” and from “Pepsi”. In this exemplary case, while both “Coke” and “Pepsi” might both want to reach “user's who are 85% likely to purchase a case of soft drink within the next 2 days”, “Pepsi” might be willing to pay more for the advertisement placement than “Coke” if the user's offline behaviors indicate a preference for “Coke” (and thus seize the chance to take a sale from a competitor). Still continuing this example, the aspect of the online user's offline profile used to suggest offline activity (see operation 450) might be any arbitrary aspect. The aspect might be the suggestion (e.g. with a coupon) of a visit to a retail outlet selected from the user's offline profile, and matched with a retail outlet where “Pepsi” is running a sales campaign.

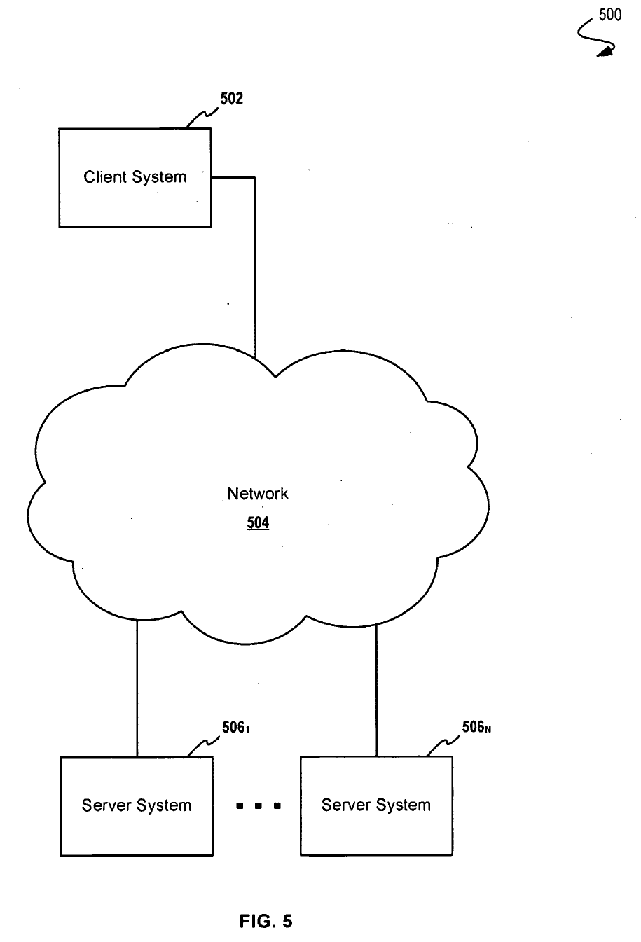

FIG. 5 illustrates a network environment 500 for operation of the system 100. As an option, the present system 500 may be implemented in the context of the architecture and functionality of FIG. 1 through FIG. 4. Of course, however, the system 500 or any operation therein may be carried out in any desired environment. The network environment 500 may include a client system 502 coupled to a network 504 (such as the Internet, an intranet, an extranet, a virtual private network, a non-TCP/IP based network, any LAN or WAN, or the like) and server systems 506₁ to 506_{N}. A server system may include a single server computer or a number of server computers. Client system 502 may be configured to communicate with any of server systems 506₁ to 506_{N}, for example, to request and receive base content (e.g. in the form of search results, or web pages, or an album of photographs, etc) and additional content (e.g. advertisements, banners, etc).

Client system 502 may include a desktop personal computer, workstation, laptop, PDA, cell phone, any wireless application protocol (WAP) enabled device, or any other device capable of communicating directly or indirectly to a network. Client system 502 typically may run a web-browsing program that may allow a user of client system 502 to request and receive content from server systems 506₁ to 506_{N} over network 504. Client system 502 may include one or more user interface devices (such as a keyboard, a mouse, a roller ball, a touch screen, a pen or the like) to interact with a graphical user interface (GUI) of the web browser on a display (e.g. monitor screen, LCD display, etc).

In some embodiments, client system 502 and/or system servers 506₁ to 506_{N} may be configured to perform the methods described herein. The methods of some embodiments may be implemented in software or hardware configured to optimize the selection of additional content to be displayed to a user.

An ad server may include a computer server, such as a web server, that may store advertisements used in online marketing and may deliver them to website visitors by placing the advertisements on websites. In one example, client system 502 and/or system servers 506₁ to 506_{N} may include or be part of an ad server. In addition to updating the contents of the web server so that the website or web page on which the ads are displayed may contain new advertisements, the ad server may perform various other tasks such as counting the number of impressions/clicks for an ad campaign and report generation. The ad server may be a local ad server run by a single publisher and serve ads to that publisher's domains or may be a third-party, remote ad server that serves ads across domains that may be owned by multiple publishers.

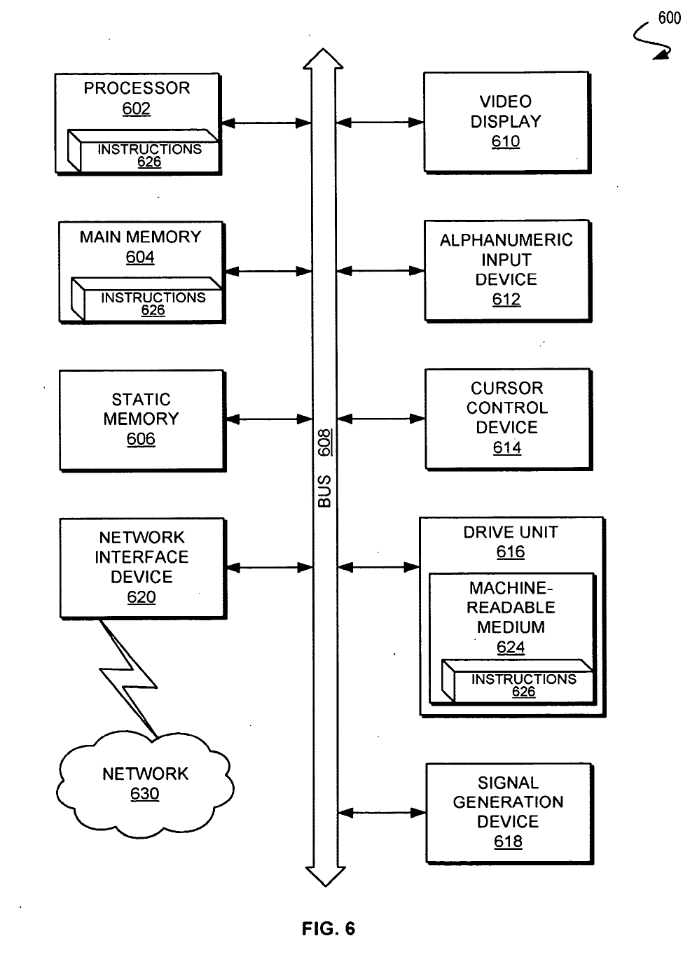

FIG. 6 is a diagrammatic representation of a machine in the exemplary form of a computer system 600, within which a set of instructions for causing the machine to perform any one of the methodologies discussed above may be executed. The embodiment shown is purely exemplary, and might be implemented in the context of one or more of FIG. 1 through FIG. 5. In alternative embodiments, the machine may comprise a network router, a network switch, a network bridge, a Personal Digital Assistant (PDA), a cellular telephone, a web appliance or any machine capable of executing a sequence of instructions that specify actions to be taken by that machine.

The computer system 600 includes a processor 602, a main memory 604 and a static memory 606, which communicate with each other via a bus 608. The computer system 600 may further include a video display unit 610 (e.g. a liquid crystal display (LCD) or a cathode ray tube (CRT)). The computer system 600 also includes an alphanumeric input device 612 (e.g. a keyboard), a cursor control device 614 (e.g. a mouse), a disk drive unit 616, a signal generation device 618 (e.g. a speaker), and a network interface device 620.

The disk drive unit 616 includes a machine-readable medium 624 on which is stored a set of instructions (i.e. software) 626 embodying any one, or all, of the methodologies described above. The software 626 is also shown to reside, completely or at least partially, within the main memory 604 and/or within the processor 602. The software 626 may further be transmitted or received via the network interface device 620 over the network 630.

It is to be understood that embodiments of this invention may be used as, or to support, software programs executed upon some form of processing core (such as the CPU of a computer) or otherwise implemented or realized upon or within a machine or computer readable medium. A machine readable medium includes any mechanism for storing or transmitting information in a form readable by a machine (e.g. a computer). For example, a machine readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc.); or any other type of media suitable for storing or transmitting information.

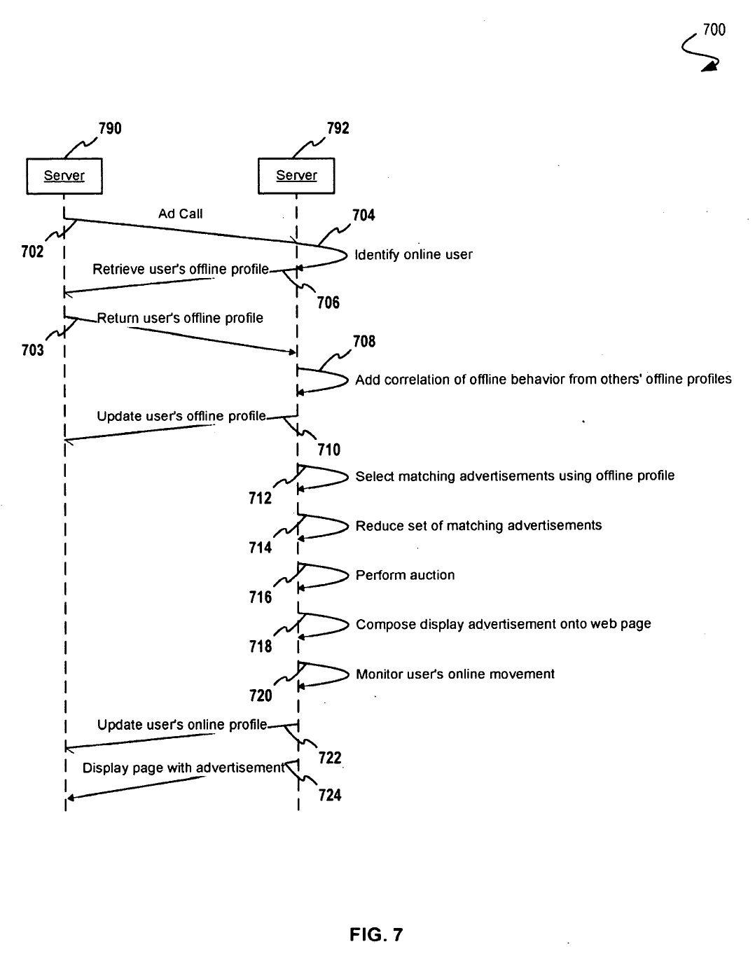

FIG. 7 is a diagrammatic representation of several computer systems (i.e. server 790, server 792) in the exemplary form of a server network 700 within which environment a communication protocol may be executed. The embodiment shown is purely exemplary, and might be implemented in the context of one or more of FIG. 1 through FIG. 6. The system 700 implements communication protocol used in a system for deep targeting advertisement based on social behaviors. As shown the operations serve for passing messages and performing operations that may occur in synchronicity as shown, or the messages and operations that may occur with one or more asynchronous messages and operations.

In the protocol shown, an ad call (see message 702) is transmitted, which results in an operation to identify the specific user (see operation 704) that hit the web page spawning the ad call. The subject user's online profile is retrieved (not shown) as is the user's offline profile (see message 706). In some cases, a specific user might not have any recorded offline profile, and in such a case that user's offline profile is seeded with values from offline behavior from other users' offline profiles where other users' are in some way correlated to the subject user (see operation 708). Execution of operation 708 might result in new information pertaining to the subject user's offline profile, and thus the subject user's offline profile is updated in a synchronous or asynchronous operation triggered by a message (see message 710). Now, having some form of the subject user's offline profile, operation 712 may set about to select candidate matching advertisements. Selection from among the candidates may be performed by any of a wide variety of selection/scoring techniques (see operation 714) and might possibly include one or more auctions (see operation 716). Given at least one advertisement that is selected for display, then the selected advertisement is composited into a complete web page to be displayed to the subject user (see operation 718). In some embodiments, the subject user's movements and behaviors are captured over some period of time (see operation 720), and in the event that there are movements and/or behaviors to be recorded in the user's online profile, such a message might be sent (see message 722). Of course, the web page as requested by the subject user that resulted in the ad call 702 is then displayed with the selected advertisement (see message 724).

The information disclosed herein is provided merely to illustrate principles and should not be construed as limiting the scope of the subject matter of the terms of the claims. The written specification and figures are, accordingly, to be regarded in an illustrative rather than a restrictive sense. Moreover, the principles disclosed may be applied to achieve the advantages described herein and to achieve other advantages or to satisfy other objectives, as well.

What is claimed is:

1. A method to display an online advertisement to an online user based on offline behavior profiles, the method comprising:
identifying offline behavior of the online user;
matching the online user's online profile to at least one online user's offline profile;
correlating at least one first aspect of the online user's offline profile to at least one second aspect of an online advertisement profile; and
using at least one third aspect of the online user's offline profile to select at least one online advertisement for online display.

2. The method of claim 1, wherein identifying offline behavior includes at least one of, site visited, a transaction amount, a stated retail preference, retail loyalty card, an offline event, a periodicity of an event, a social network setting.

3. The method of claim 1, wherein identifying offline behavior includes classifying behavior into at least one category selected from the group, location of event, size of expenditure, nature of event, frequency of event, periodicity of event.

4. The method of claim 1, wherein identifying offline behavior includes predicting behavior based on correlated users.

5. The method of claim 1, wherein matching the online user's online profile to at least one online user's offline profile includes matching at least one of, a name, an address, a social security number, a user ID, a payment method, a event pattern, brand-derived behavior.

6. The method of claim 1, wherein matching the online user's online profile to at least one online user's offline profile includes using at least one of, a rule, a rule set, a predictive model, a plurality of predictive models.

7. The method of claim 1, wherein the first aspect is the same aspect as the third aspect.

8. A computer readable medium comprising a set of instructions which, when executed by a computer, cause the computer to display an online advertisement to an online user based on offline behavior profiles, the instructions for:
identifying offline behavior of the online user;
matching the online user's online profile to at least one online user's offline profile;
correlating at least one first aspect of the online user's offline profile to at least one second aspect of an online advertisement profile; and
using at least one third aspect of the online user's offline profile to select at least one online advertisement for online display.

9. The computer readable medium of claim 8, wherein identifying offline behavior includes at least one of, site visited, a transaction amount, a stated retail preference, retail loyalty card, an offline event, a periodicity of an event, a social network setting.

10. The computer readable medium of claim 8, wherein identifying offline behavior includes classifying behavior into at least one category selected from the group, location of event, size of expenditure, nature of event, frequency of event, periodicity of event.

11. The computer readable medium of claim 8, wherein identifying offline behavior includes predicting behavior based on correlated users.

12. The computer readable medium of claim 8, wherein matching the online user's online profile to at least one online user's offline profile includes matching at least one of, a name, an address, a social security number, a user ID, a payment method, a event pattern, brand-derived behavior.

13. The computer readable medium of claim 8, wherein matching the online user's online profile to at least one online user's offline profile includes using at least one of, a rule, a rule set, a predictive model, a plurality of predictive models.

14. The computer readable medium of claim 8, wherein the first aspect is the same aspect as the third aspect.

15. An ad server network for display of an online advertisement to an online user based on offline behavior profiles, the server network comprising:
a module for identifying offline behavior of the online user;
a module for matching the online user's online profile to at least one online user's offline profile;
a module for correlating at least one first aspect of the online user's offline profile to at least one second aspect of an online advertisement profile; and
a module for using at least one third aspect of the online user's offline profile to select at least one online advertisement for online display.

16. The server network of claim 15, wherein identifying offline behavior includes at least one of, site visited, a transaction amount, a stated retail preference, retail loyalty card, an offline event, a periodicity of an event, a social network setting.

17. The server network of claim 15, wherein identifying offline behavior includes classifying behavior into at least one category selected from the group, location of event, size of expenditure, nature of event, frequency of event, periodicity of event.

18. The server network of claim 15, wherein identifying offline behavior includes predicting behavior based on correlated users.

19. The server network of claim 15, wherein matching the online user's online profile to at least one online user's offline profile includes matching at least one of, a name, an address, a social security number, a user ID, a payment method, a event pattern, brand-derived behavior.

20. The server network of claim 15, wherein matching the online user's online profile to at least one online user's offline profile includes using at least one of, a rule, a rule set, a predictive model, a plurality of predictive models.
